(19) United States
(12) Patent Application Publication
(10) Pub. No.: US 2012/0236159 A1
(43) Pub. Date: Sep. 20, 2012

(54) IMAGE TRANSFER DEVICE, IMAGE TRANSFER METHOD, AND COMPUTER PROGRAM PRODUCT

(75) Inventor: Nobuhiro Tamura, Nagoya-shi (JP)

(73) Assignee: Buffalo Inc., Nagoya-shi (JP)

(21) Appl. No.: 13/412,670

(22) Filed: Mar. 6, 2012

(30) Foreign Application Priority Data
Mar. 18, 2011 (JP) 2011-060146

(51) Int. Cl. H04N 5/225

(52) U.S. Cl. 348/207.1; 348/E05.024

(57) ABSTRACT

An image transfer device, as well as a method and computer program product, obtains an image file that includes first image data and identification information for identifying an image generation device used to generate the first image data, and obtains the identification information from the obtained image file. The image transfer device determines a display resolution of a monitor included in the image generation device, according to the obtained identification information, converts the first image data to second image data having a resolution consistent with the determined display resolution, and records the second image data into a storage device. The image transfer device transfers the obtained image file to a first device connected to the network.

### CROSS-REFERENCE TO RELATED APPLICATION

This application claims priority to Japanese Patent Application No. 2011-60146, entitled: “IMAGE TRANSFER DEVICE AND IMAGE TRANSFER METHOD” filed in the Japanese Patent Office on Mar. 18, 2011, which is hereby incorporated by reference in its entirety.

### BACKGROUND

1. Technical Field

The contents of the present disclosure relates to image transfer technology.

2. Related Art

As an example of conventional image transfer technology, JP2006-157517A describes a technique where a digital camera backs up (transfers) each taken image to a personal computer, while reducing the taken image according to the display resolution of a monitor included in the digital camera and recording the reduced image in a storage of the digital camera. This technique does not require to store images of large data volumes in the storage of the digital camera, thus saving the capacity of a storage medium used for the storage.

This technique, however, reduces the taken image according to the display resolution of the monitor included in the digital camera and accordingly uses a fixed reduction ratio. The manufacturer of the digital camera is thus required to set the reduction ratio corresponding to the display resolution of the monitor included in the digital camera in an internal program or in a built-in circuit, with respect to each model of the digital camera or at every time of introduction of a new model, which results in relatively poor versatility. This problem is not characteristic of the digital camera, but is commonly found in various devices with the function of transferring taken images, for example, personal digital assistants such as smartphones with camera functions.

Consequently, as recognized by the present inventor, there is a need to enable an image transfer device to flexibly convert the resolution of an image according to the resolution of a monitor included in a device used to display a reduced image.

### SUMMARY

According to an aspect of the disclosure, there is provided an image transfer device capable of communicating via a network. The image transfer device comprises: a non-transitory storage device; an image file obtainer that obtains an image file that includes first image data and identification information for identifying an image generation device used to generate the first image data; an identification information obtainer that obtains the identification information from the obtained image file; a resolution determiner that determines a display resolution of a monitor included in the image generation device, according to the obtained identification information; a resolution converter that converts the first image data into second image data having a resolution consistent with the determined display resolution and stores the second image data into the storage device; and an image transferrer tranfers the obtained image file to a first device connected to the network. The image transfer device according to this aspect determines the display resolution of the monitor included in the image generation device, based on the identification information for identifying the image generation device used to generate the first image data included in the image file. The resolution of the first image data can thus be flexibly converted according to the display resolution of the monitor included in the image generation device.

In the image transfer device according to the above aspect, the resolution determiner may refer to a resolution table that has the display resolution of the monitor included in the image generation device stored in association with the identification information, and determine the display resolution. In the image transfer device according to the above aspect, the resolution table may be stored in a second device connected to the network, and the resolution determiner may refer to the resolution table stored in the second device via the network. This does not require to store the resolution table in the image transfer device, so that the resolution table can be updated easily. The first device and the second device may be identical devices or different devices.

In the image transfer device according to the above aspect, the identification information obtainer may start obtaining the identification information at a timing of at least one of a timing when the image file is recorded in the storage, a timing when connection of the image transfer device to the network is detected, and a timing when the image transfer device is powered on. This ensures image transfer and resolution conversion at various timings.

In the image transfer device according to the above aspect, the resolution converter may calculate a conversion ratio used to convert the resolution, based on a vertical resolution of the first image data and a vertical resolution of the display resolution. This calculates the conversion ratio for converting the resolution, based on the vertical resolution of the first image data and the vertical resolution of the display resolution, so that the image can be displayed over the entire screen of the monitor even when the first image data has a horizontally longer aspect ratio than the aspect ratio of the monitor.

In the image transfer device according to the above aspect, the image transfer device may be included in a removable storage device that is removably attachable to the image generation device. This provides the image transfer device of the recording medium structure, thus enabling transfer of the image file and resolution conversion of the image data without using the functions of the image generation device.

In the image transfer device according to the above aspect, the image transferrer may transfer the image file by wireless communication. This enables transfer of the image file by wireless communication, thus allowing the image file to be transferred from various locations. Any of various communication modes, such as wireless LAN, mobile communication network or infrared radiation may be applied for the wireless communication.

In the image transfer device according to the above aspect, the image file may be stored in the storage device, and the image file obtainer may obtain the image file from the storage device. In the image transfer device according to the above aspect, the image file obtainer deletes the obtained image file from the storage, after the image transferrer transfers the obtained image file to the first device. This enables effective use of the storage resource.

Other embodiments may be implemented in the form of an image transfer method and a non-transitory computer program product for image transfer, in addition to the image transfer device described above. The computer program product includes a program (program codes) recorded in a computer readable recording medium. Any of various non-transitory media, such as flexible disk, CD-ROM, DVD-ROM, magneto-optical disk, memory card, and hard drive, may be used as the recording medium.

### BRIEF DESCRIPTION OF THE DRAWINGS

FIG. 1 illustrates the general configuration of an image upload system including a removable storage device according to a first embodiment of the invention;

FIG. 2 is a block diagram showing the internal structure of the removable storage device;

FIG. 3 is a flowchart of image upload routine;

FIG. 4 is a block diagram showing a removable storage device according to a second embodiment;

FIG. 5 is a flowchart of table obtaining routine;

FIG. 6 illustrates the general configuration of an image upload system including a router according to a third embodiment of the invention;

FIG. 7 is a block diagram showing the internal structure of the router;

FIG. 8 illustrates the general configuration of an image upload system including a cell phone according to a fourth embodiment of the invention; and

FIG. 9 is a block diagram showing the internal structure of the cell phone.

### DETAILED DESCRIPTION

### A. First Embodiment

A-1. System Configuration The disclosure is described in detail with reference to some embodiments.

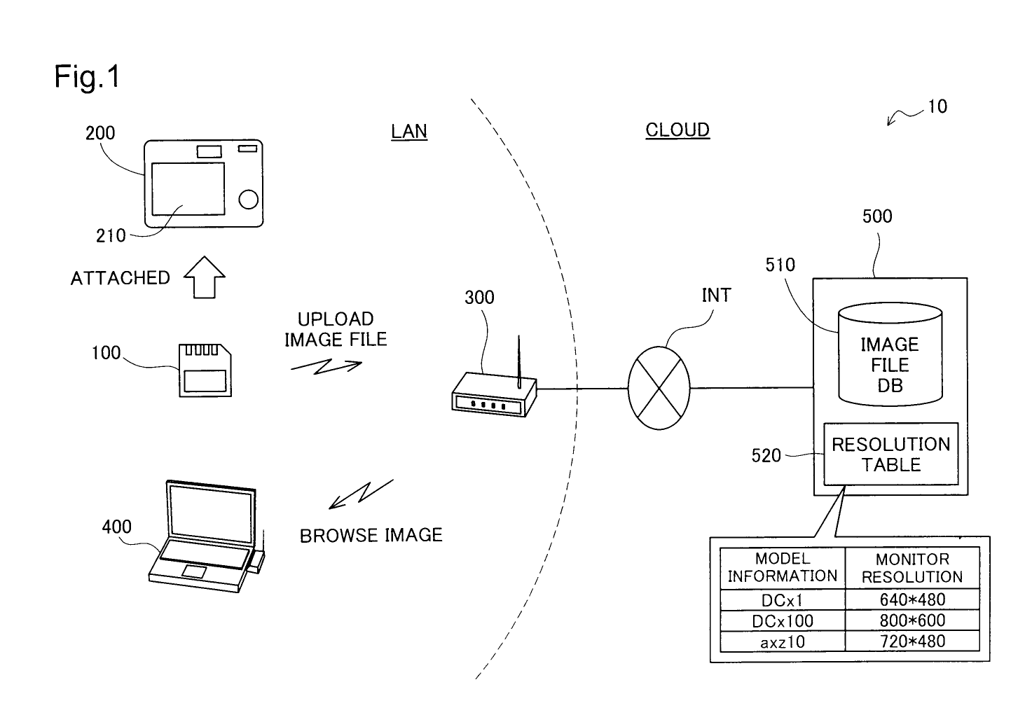

FIG. 1 illustrates the general configuration of an image upload system including a removal storage device according to a first embodiment of the invention. The image upload system 10 includes a removable storage device 100, an imaging device 200, a router 300, a computer 400 and a cloud server 500. For example, a digital still camera or a digital video camera may be used as the imaging device 200. The router 300 includes the functions of a wireless LAN access point. The computer 400 includes the functions of a wireless LAN client. The cloud server 500 has the functions of an online album. The router 300 and the cloud server 500 are interconnected to be communicable via the Internet INT.

The removable storage device 100 is a non-transitory (i.e., not a transitory signal) memory device removably attached to the imaging device 200. When an image file generated by the imaging device 200 is recorded, the removable storage device 100 serves to transfer the recorded image file by a wireless communication circuit provided inside the removable storage device 100 via the router 300 to the cloud server 500 on the Internet INT.

When receiving the transferred image file, the cloud server 500 stores the received image file into its own image file database 510. The image file stored in the cloud server 500 may be browsed or downloaded through the computer 400 by utilizing the online album services provided by the cloud server 500 via the Internet INT. A destination (address), to which the image file is to be transferred by the removable storage device 100, may be set arbitrarily by a predetermined application executed on the computer 400. Information on the preset transfer destination (address) is recorded into the removable storage device 100 connected with the computer 400 via a card reader/writer. In subsequent image transfer, the removable storage device 100 refers to the recorded information on the transfer destination and performs an image transfer process. By changing the transfer destination of the image file, the removable storage device 100 may also transfer the image file within the LAN, for example, to the computer 400 in the LAN, in addition to the cloud server 500 on the Internet INT.

According to this embodiment, when transferring an image file to the cloud server 500, the removable storage device 100 serves to reduce image data included in the transferred image file and store the reduced image data. The removable storage device 100 automatically adjusts the reduction ratio for image reduction, based on a resolution table 520 stored in the cloud server 500. In the resolution table 520, the resolution of a monitor 210 included in the imaging device 200 (hereinafter called “monitor resolution”) is recorded in correlation to each model information representing the model of the imaging device 200. The removable storage device 100 can thus reduce the image to an optimum size to be displayed on the monitor 210 of the imaging device 200. The following describes the structure and the processing for implementing these functions of the removable storage device 100 in detail.

A-2. Structure of Removable Storage Device

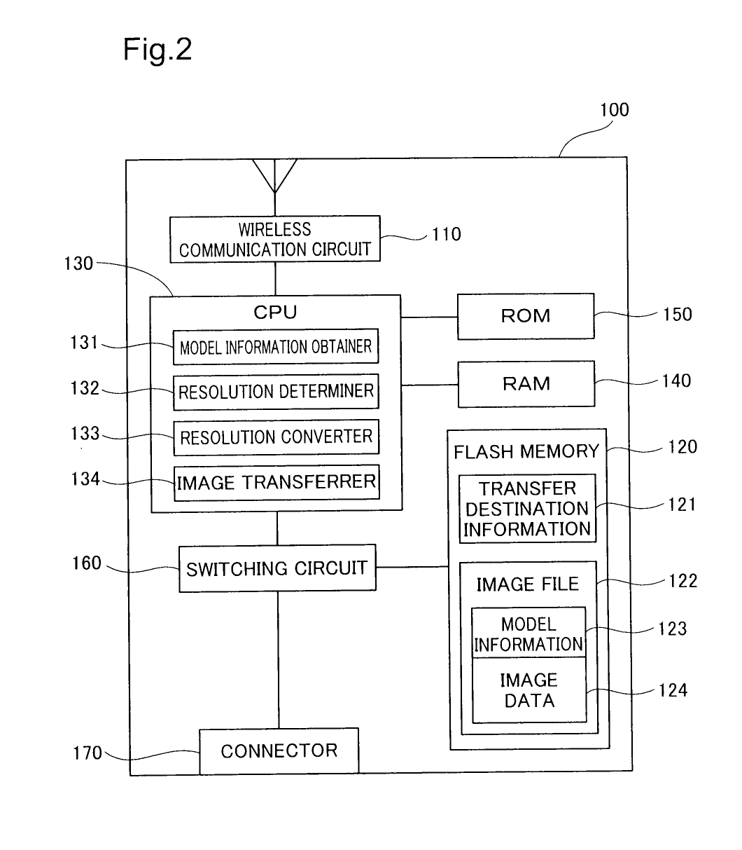

FIG. 2 is a block diagram showing the internal structure of the removable storage device 100. The removable storage device 100 includes a wireless communication circuit 110, a flash memory 120, a CPU 130, a RAM 140, a ROM 150, a switching circuit 160 and a connector 170. The removable storage device 100 has a card form according to this embodiment but may be any arbitrary form that is attachable to and detachable from the imaging device 200.

The wireless communication circuit 110 includes an antenna, an RF transceiver and a baseband processor and controls wireless communication conforming to the IEEE 802.11 standard. In response to an instruction from the CPU 130, the wireless communication circuit 110 makes communication with the cloud server 500 via the router 300. The address of the cloud server 500 is stored in advance as transfer destination information 121 in the flash memory 120.

The flash memory 120 is a rewritable non-volatile memory, in which an image filer 122 is recorded. According to this embodiment, the image file conforms to the EXIF (Exchangeable Image File Format) standard. The image file conforming to the EXIF standard includes header information and image data 124. Identification information for identifying the device used to take image data (imaging device 200), such as model information representing the model, as well as the shooting date and time of the image, the shutter speed, the aperture, and the color space are recorded as the header information. As long as the model information is recorded in the image file, the format of the image file is not limited to the EXIF format. Various information enabling model-based identification or unequivocal identification of the imaging device, such as, serial number, type, firmware version, may be used for the identification information.

The connector 170 has a power terminal and a data terminal as connection terminals to be electrically connected with the internal bus of the imaging device 200. The removable storage device 100 receives power supply from the imaging device 200 through the power terminal of the connector 170, while obtaining an image file from the imaging device 200 through the data terminal of the connector 170.

The switching circuit 160 is a circuit structured to switch the connection of the flash memory 120 to either the connector 170 or the CPU 130, in response to an instruction from the CPU 130. The connection of the flash memory 120 to the connector 170 by the switching circuit 160 enables the imaging device 200 to read and write an image file from and into the flash memory 120. The connection of the flash memory 120 to the CPU 130 by the switching circuit 160 enables the CPU 130 to read and write an image file from and into the flash memory 120. The switching circuit 160 has the bridge function. While the flash memory 120 is connected to the connector 170, this bridge function enables the switching circuit 160 to transfer a command sent from the imaging device 200 toward the flash memory 120 (for example, write command, read command or delete command) to the CPU 130, as well as the flash memory 120.

The CPU 130 loads and executes a control program (firmware) recorded in advance in the ROM 150, onto the RAM 140, so as to serve as a model information obtainer 131, a resolution determiner 132, a resolution converter 133 and an image transferrer 134. The control program may be stored in the flash memory 120.

The model information obtainer 131 serves to obtain model information from the image file 122 stored in the flash memory 120. The resolution determiner 132 serves to refer to the resolution table 520 (FIG. 1) and determine the monitor resolution corresponding to the model information obtained by the model information obtainer 131. The resolution converter 133 serves to reduce the resolution of the image data 124 included in the image file 122, based on the determined monitor resolution. The image transferrer 134 serves to transfer the image file 122 to the cloud server 500 by using the wireless communication circuit 110.

A-3. Image Upload Routine

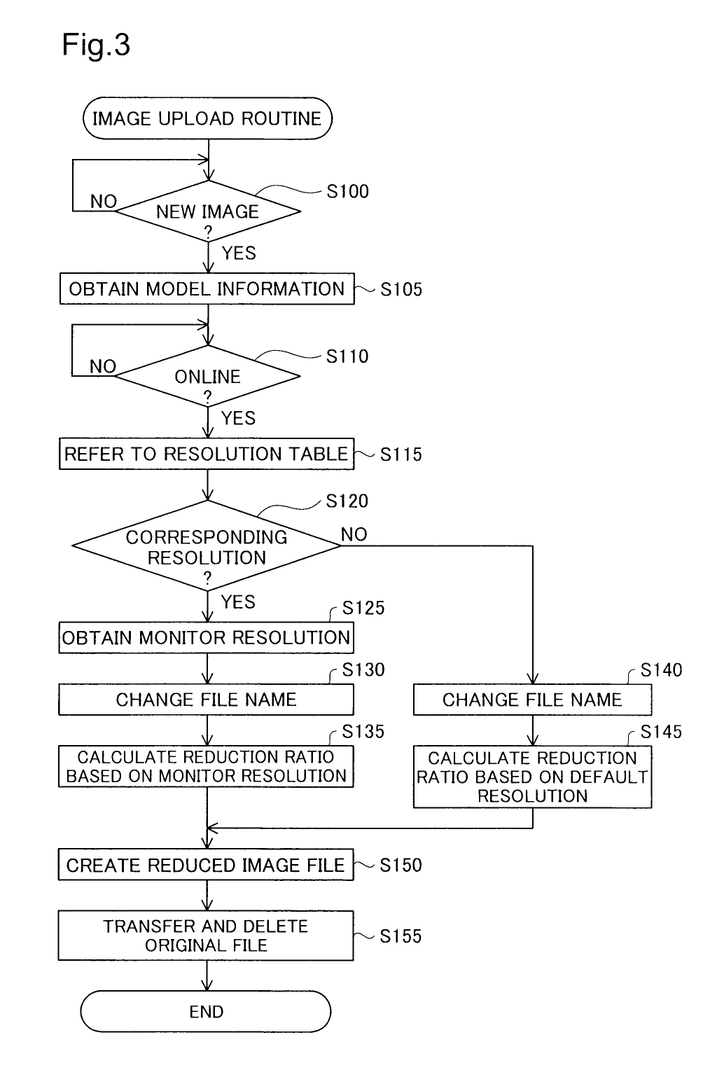

FIG. 3 is a flowchart of image upload routine performed by the removable storage device 100. This image upload routine is repeated during power supply from the imaging device 200 to the removable storage device 100.

On the start of the image upload routine, the CPU 130 first checks whether a new image file (hereinafter also called “original file”) is recorded in the flash memory 120 (step S100). When no new image file is recorded (step S100: No), the CPU 130 waits until a new image file is recorded, by the loop of this step S100.

When a new image file is recorded (step S100: Yes), the CPU 130 or specifically its model information obtainer 131 obtains the model information included in the new image file (step S105). After obtaining the model information, the CPU 130 checks whether the removable storage device 100 is online, that is, whether the CPU 130 itself is accessible to the cloud server 500 (step S110). When not online (step S110: No), the CPU 130 waits for online. When online (step S110: Yes), on the other hand, the CPU 130 or specifically its resolution determiner 132 refers to the resolution table 520 stored in the cloud server 500 (step S115).

The resolution determiner 132 refers to the resolution table 520 and checks whether the resolution table 520 has registry of the monitor information corresponding to the model information obtained at step S105 (step S120). When there is any registry of the corresponding monitor information (step S120: Yes), the resolution determiner 132 obtains the monitor resolution from the resolution table 520 (step S125). The resolution determiner 132 changes the file name of the original file according to a preset rule (step S130) and calculates the reduction ratio for reducing the image data included in the original file (step S135). When the header of the image file includes description on the monitor resolution of the imaging device, the determination of the resolution may refer to the description to determine the monitor resolution.

The processing of step S135 calculates the reduction ratio, based on the ratio of the vertical resolution of the monitor resolution obtained at step S125 to the vertical resolution of the image data included in the original file. More specifically, reduction ratio R is expressed by Equation (1) given below, where Y1 denotes the vertical resolution of the monitor resolution and Y2 denotes the vertical resolution of the image data included in the original file:

R=Y1/Y2 (1)

When the resolution table 520 has no registry of the monitor resolution corresponding to the monitor information obtained at step S105 (step S120: No), the resolution determiner 132 changes the file name of the original file (step S140) in the same manner as step S130 and calculates the reduction ratio by Equation (1) given above with using a predetermined default vertical resolution (for example, 480 pixels) for the monitor resolution Y1 (step S145).

After calculating the reduction ratio R at either step S135 or step S145, the CPU 130 or specifically its resolution converter 133 performs resolution conversion with the reduction ratio R to newly create a reduced image file (hereinafter also called “reduced file”) from the original file (step S150). The CPU 130 sets the original file name before being changed at either step S130 or step S140 to the file name of the created reduced file and records the reduced file into the flash memory 120. The storage of the flash memory 120 at this stage accordingly includes the reduced file with the original file name and the original file with the changed file name. In order to suppress degradation of the image quality, any of known bicubic interpolation, bilinear interpolation or nearest neighbor interpolation may be performed during the resolution conversion.

After creating the reduced file in the above manner, the CPU 130 or specifically its image transferrer 134 transfers the original file to the cloud server 500 and deletes the original file from the flash memory 120 (step S155).

In the image upload system 10 according to the embodiment described above, when a new image file is recorded in the removable storage device 100 by the imaging device 200, the recorded image file is automatically transferred to the cloud server 500. The removable storage device 100 refers to the resolution table 520, based on the model information included in the recorded image file, and obtains the monitor resolution corresponding to the model information. The removable storage device 100 can thus flexibly adjust the reduction ratio of the image data according to the model of the imaging device 200, to which the removable storage device 100 is attached. According to the embodiment, storing the reduced image in the removable storage device 100 advantageous decreases the data volume to be stored. Additionally, adjusting the reduction ratio of the image data according to the model of the imaging device 200 enhances the display quality in preview of each taken image by the imaging device 200. Storing the reduced image in the removable storage device 100 ensures the prompt display of a preview image on the imaging device 200.

According to this embodiment, the resolution table 520 is stored in the cloud server 500 that is the different device from the removable storage device 100, so that the resolution table 520 can be updated easily when a new imaging device comes to market.

Additionally, according to this embodiment, the image reduction procedure calculates the reduction ratio, based on the ratio of the vertical resolution of the monitor resolution obtained from the resolution table 520 to the vertical resolution of the image data included in the original file. When the image data has the aspect ratio of 16:9 or 16:10 or the landscape ratio like the panoramic size, the image display can use the vertical resolution of the monitor 210 to its full extent without causing any non-displayed black zones on upper and lower edges of the monitor 210. A landscape-oriented image displayed on the monitor 210 may be fully seen on the imaging device 200 by automatically or manually scrolling the image horizontally.

In the first embodiment described above, during execution of the image upload routine shown in FIG. 3, a preset command may be sent to the imaging device 200, in order to prevent the imaging device 200 from being powered off. This prevents the processing from being unintentionally interrupted during transfer of the image and protects the image file from being lost.

In the first embodiment described above, at the power-on of the removable storage device 100, when the CPU 130 detects that the original file remains in the flash memory 120, the processing of and after step S110 shown in FIG. 3 may be performed. This enables the original file to be retransferred in the case of a failed image transfer, for example, due to accidental power-off during image transfer.

The image upload routine according to this embodiment obtains the model information from the image file, after detecting the presence of a new image file but before checking for the online state. Alternatively the model information may be obtained after the online state is confirmed.

Besides, the image upload routine shown in FIG. 3 may be performed at the timing when a command for image transfer is received from the imaging device 200. When the imaging device 200 does not have a command for image transfer, the image upload routine may be performed with regarding an image file write command, read command or delete command as the command for image transfer.

### B. Second Embodiment

The removable storage device 100 according to the first embodiment described above obtains the monitor resolution from the resolution table 520 stored in the cloud server 500. A removable storage device 100b according to a second embodiment, on the other hand, downloads the resolution table 520 in advance into the flash memory 120, before obtaining the monitor resolution.

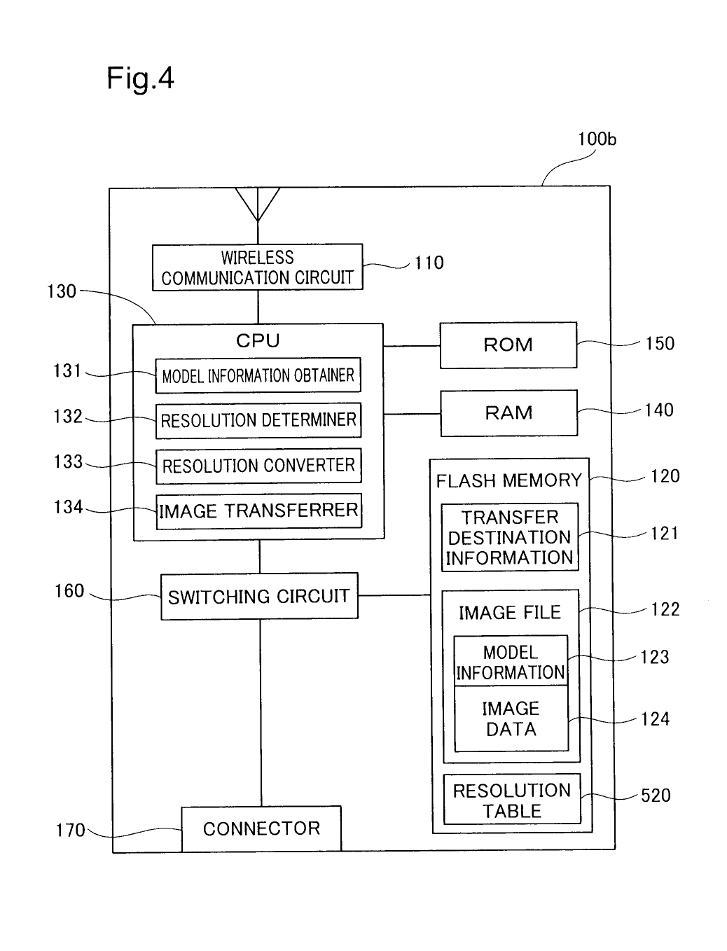

FIG. 4 is a block diagram showing the internal structure of the removable storage device 100b according to the second embodiment. As illustrated, in this removable storage device 100b, the resolution table 520 is stored in the flash memory 120. The removable storage device 100b of this embodiment performs the image upload routine shown in FIG. 3 like the first embodiment, but refers to the resolution table 520 in its own flash memory 120 instead of the cloud server 500 at step S115 and obtains the monitor resolution from this resolution table 520 at step S125.

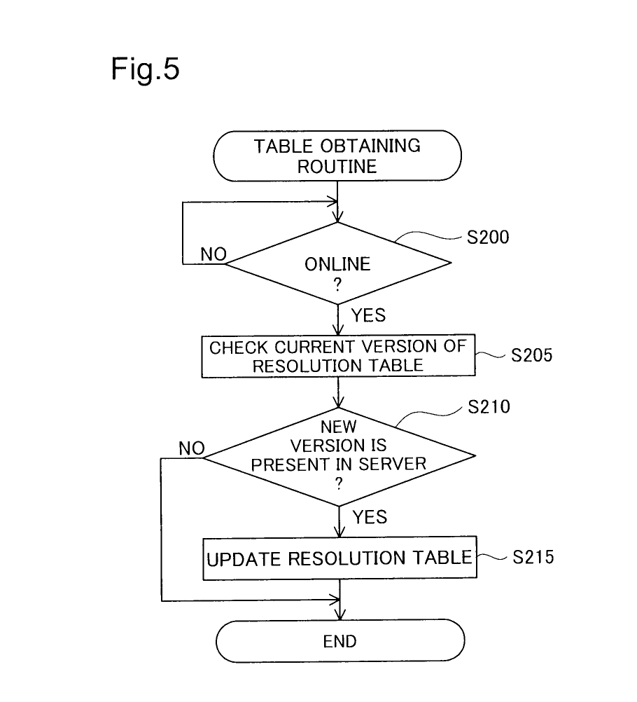

FIG. 5 is a flowchart of table obtaining routine, according to which the removable storage device 100b obtains the resolution table 520 from the cloud server 500. This table obtaining routine is repeated during power supply to the removable storage device 100b and is performed independently of and in parallel with the image upload routine shown in FIG. 3.

On the start of this table obtaining routine, the CPU 130 first checks whether the removable storage device 100b is online (step S200). When online (step S200: Yes), the CPU 130 checks the version of the resolution table 520 stored in the flash memory 120 (step S205). The CPU 130 then queries the cloud server 500 for storage of a newer version resolution table 520 than the currently stored version (step S210) and downloads the newer version resolution table 520 and updates the resolution table 520 stored in the flash memory 120 (step S215) when there is the newer version resolution table 520 (step S210: Yes). The version information is attached to the resolution table 520 according to this embodiment, but checking the cloud server 500 for storage of the newer resolution table 520 may be based on the date and time of creation or update of the resolution table 520.

The removable storage device 100b according to the second embodiment described above refers to the resolution table 520 stored in its own flash memory 120, instead of the resolution table 520 stored in the cloud server 500, so as to obtain the monitor resolution promptly. The resolution table 520 is merely the data of the monitor resolution correlated to the model information and has extremely small data volume relative to the overall storage capacity of the flash memory 120. Storing the resolution table 520 accordingly has no significant effect on the storage capacity of the flash memory 120.

The table obtaining routine shown in FIG. 5 is continually repeated during power supply to the removable storage device 100b according to this embodiment, but may be performed only once at the power-on. The table obtaining routine may be performed at preset time intervals.

The resolution table 520 is downloaded from the cloud server 500 according to this embodiment, but the resolution table 520 may be recorded in the flash memory 120 before shipment of the removable storage device 100b. According to another embodiment, the computer 400 may download the resolution table 520 and write the resolution table 520 into the removable storage device 100b. In such cases, the processing of step S110 in FIG. 3, i.e., checking for the access to the cloud server 500 (in other words, checking whether the resolution table 520 is obtainable from the cloud server 500) may be omitted.

### C. Third Embodiment

The first embodiment and the second embodiment describe the application of the image transfer device according to the invention to the removable storage device. A third embodiment, on the other hand, relates to application of the image transfer device according to the invention to the router.

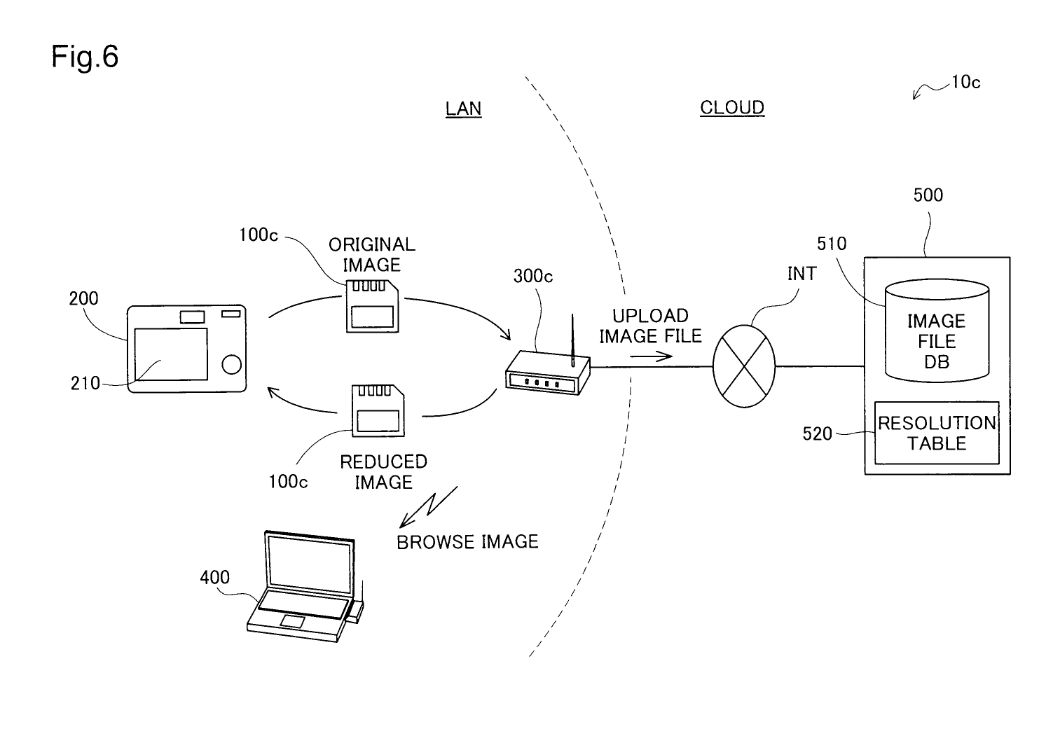

FIG. 6 illustrates the general configuration of an image upload system 10c including a router 300c according to the third embodiment of the invention. Unlike the first embodiment and the second embodiment, a removable storage device 100c of this embodiment is a general recording medium without the functions of wireless communication and image reduction. According to this embodiment, the router 300c, to which the removable storage device 100c removed from the imaging device 200 is attached, performs transfer and reduction of an image file. Each image reduced by the router 300c and stored in the removable storage device 100c can be displayed on the monitor 210 by reattachment of the removable storage device 100c to the imaging device 200.

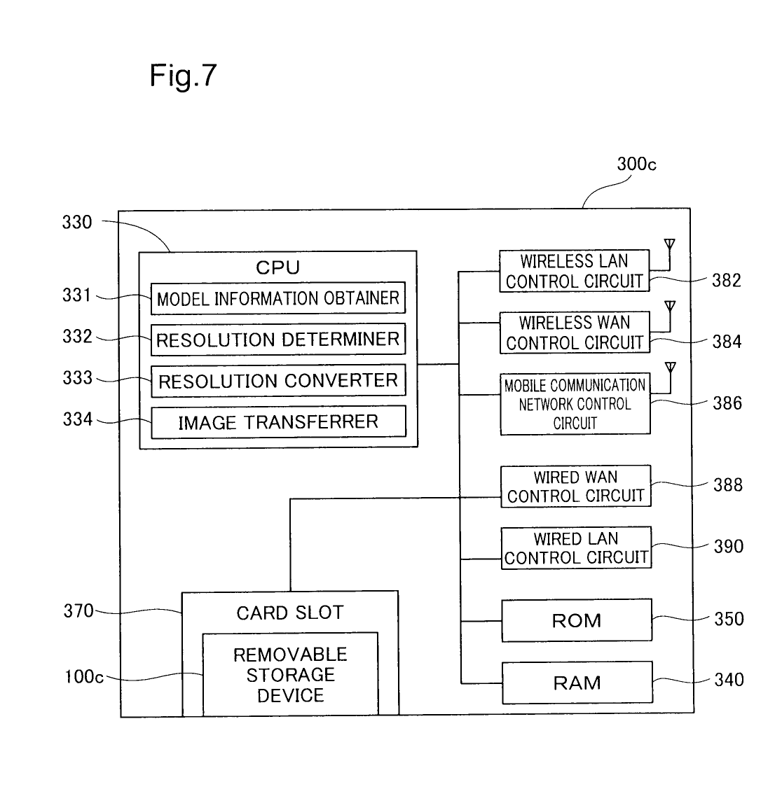

FIG. 7 is a block diagram showing the internal structure of the router 300c. The router 300c includes a wireless LAN control circuit 382, a wireless WAN control circuit 384, a mobile communication network control circuit 386, a wired WAN control circuit 388, a wired LAN control circuit 390, a CPU 330, a RAM 340, a ROM 350 and a card slot 370, in with the removable storage device 100c is inserted.

The wireless LAN control circuit 382 is a circuit structured to make wireless communication in conformity with the IEEE 802.11 standard with the computer 400 in a wireless LAN. The wireless WAN control circuit 384 is a circuit structured to control access to a public wireless LAN conforming to the IEEE 802.11 standard. The mobile communication network control circuit 386 is a circuit structured to control access to a mobile communication network, such as 3G network or PHS network. The wired WAN control circuit 388 is a circuit structured to control access to the Internet INT. The wired LAN control circuit 390 is a circuit structured to make communication with the computer 400 in a wired LAN. The CPU 330 controls these circuits 382 to 390, so as to connect the computer 400 in the wireless LAN or in the wired LAN to the Internet INT via the public wireless LAN, the mobile communication network or the wired WAN. The CPU 330 also controls the wireless WAN control circuit 384, the mobile communication network control circuit 386 or the wired WAN control circuit 388 to make access to the cloud server 500.

The CPU 330 loads and executes a control program (firmware) recorded in advance in the ROM 350, onto the RAM 340, so as to serve as a model information obtainer 331, a resolution determiner 332, a resolution converter 333 and an image transferrer 334.

The model information obtainer 331 obtains model information from an image file stored in the removable storage device 100c inserted in the card slot 370. The resolution determiner 332 refers to the resolution table 520 stored in the cloud server 500 and determines the monitor resolution (i.e., resolution of the monitor 210 of the imaging device 200) corresponding to the model information obtained by the model information obtainer 331. The resolution converter 333 reduces image data included in the image file in the removable storage device 100c according to the determined monitor resolution. The image transferrer 334 transfers the image file in the removable storage device 100c to the cloud server 500. According to this embodiment, the CPU 330 utilizes these functional blocks to perform a similar series of processing to the image upload routine shown in FIG. 3.

The router 300c according to the third embodiment described above can transfer an image file to the cloud server 500 and reduce the image data to the size corresponding to the resolution of the monitor 210 of the imaging device 200 used to create the image file. This enables transfer of the image file and reduction of the image data even when the imaging device 200 and the removable storage device 100c do not have the functions of communication.

The router 300c may not necessarily include all of the wireless LAN control circuit 382, the wireless WAN control circuit 384, the mobile communication network control circuit 386, the wired WAN control circuit 388 and the wired LAN control circuit 390. For example, one of the wireless LAN control circuit 382 and the wired LAN control circuit 390 may be omitted. Additionally, at least one of the wireless WAN control circuit 384, the mobile communication network control circuit 386 and the wired WAN control circuit 388 should be essential. In other words, the router 300c is required to have at least one LAN-based communication means and at least one WAN (Internet)-based communication means.

### D. Fourth Embodiment

The first embodiment and the second embodiment describe the application of the image transfer device according to the invention to the removable storage device. The third embodiment describes the application of the image transfer device according to the invention to the router. A fourth embodiment, on the other hand, relates to the application of the image transfer device according to the invention to the cell phone.

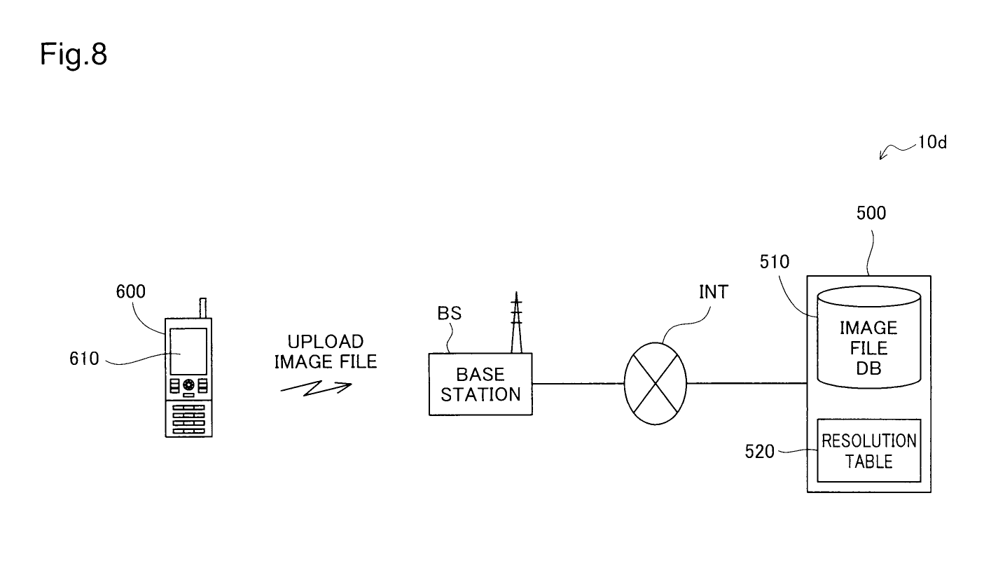

FIG. 8 illustrates the general configuration of an image upload system 10d including a cell phone 600 according to the fourth embodiment of the invention. The cell phone 600 has a camera and a flash memory. According to this embodiment, an image taken by the camera of the cell phone 600 is recorded in the flash memory, while being transferred to the cloud server 500 via a base station BS and the internet INT. Image data is reduced in the cell phone 600. More specifically, the cell phone 600 refers to the resolution table 520 stored in the cloud server 500 and reduces the image to the size suitable for the monitor resolution of the cell phone 600. The reduced image is stored in the flash memory and is displayed on a monitor 610 of the cell phone 600.

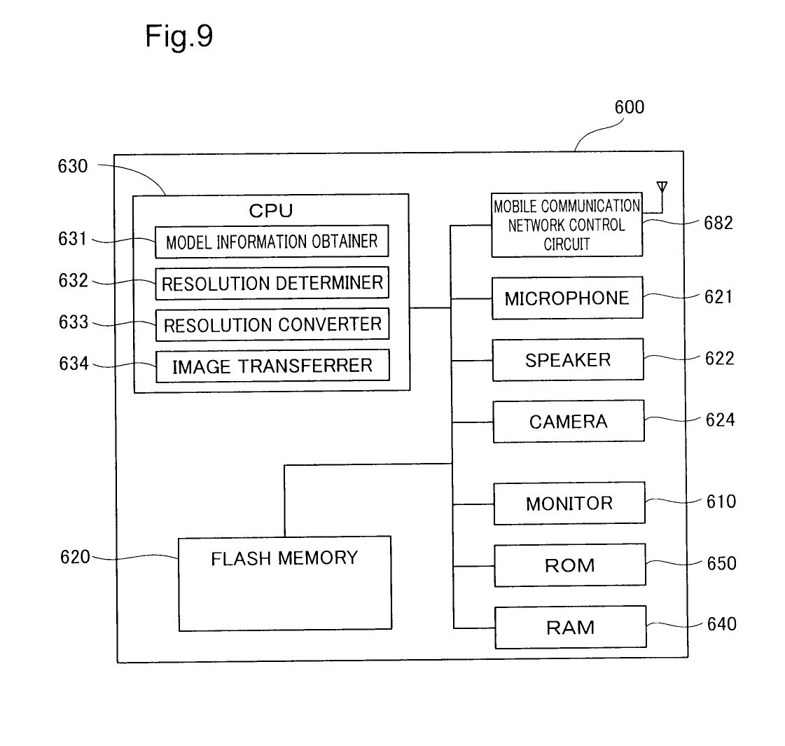

FIG. 9 is a block diagram showing the internal structure of the cell phone 600. The cell phone 600 includes a monitor 610, a flash memory 620, a microphone 621, a speaker 622, a camera 624, a CPU 630, a RAM 640, a ROM 650 and a mobile communication network control circuit 682. An image file taken by the camera 624 is recorded in the flash memory 620, and the microphone 621 and the speaker 622 are used for voice communication. Images and other information are displayed on the monitor 610.

The mobile communication network control circuit 682 is a circuit structured to control access to a mobile communication network such as 3G network or PHS network. The CPU 630 loads and executes a control program (application) recorded in the ROM 650 or the flash memory 620, onto the RAM 640, so as to serve as a model information obtainer 631, a resolution determiner 632, a resolution converter 633 and an image transferrer 634.

The model information obtainer 631 obtains model information from an image file recorded in the flash memory 620. According to this embodiment, an image taken by the built-in camera 624 of the cell phone 600 is recorded in the flash memory 620, so that the model information represents the model name of the cell phone 600 itself. The resolution determiner 632 refers to the resolution table 520 stored in the cloud server 500 and determines the monitor resolution corresponding to the model information obtained by the model information obtainer 631. The resolution converter 633 reduces image data included in the image file in the flash memory 620 according to the determined monitor resolution. The image transferrer 634 transfers the image file in the flash memory 620 to the cloud server 500. According to this embodiment, the CPU 630 also utilizes these functional blocks to perform a similar series of processing to the image upload routine shown in FIG. 3.

According to the fourth embodiment described above, when the resolution of the monitor 610 of the cell phone 600 differs among the models or grades or when the cell phone 600 works on the general-purpose operating system without fixed hardware specification, the cell phone 600 can flexibly change the size of image data according to the resolution of the monitor 610 included in the cell phone 600. This enhances the versatility of the program for reducing and displaying images.

### E. Modifications

The foregoing has described the invention in detail with reference to the illustrative embodiments. The invention is not limited to the above embodiments, but a multiplicity of variants and modifications may be made to the embodiments without departing from the scope of the invention. For example, the functions implemented by the software configuration may be implemented by the hardware configuration, or vice versa. Some examples of other possible modifications are given below.

Modification 1:

The resolution table 520 is stored in the cloud server 500 in the above embodiment, but may be stored in another server different from the cloud server 500. In other words, the object server of image upload and the server for storing the resolution table may be managed by different operators.

Modification 2:

The table obtaining routine described in the second embodiment is applicable to the first embodiment, as well as the third or fourth embodiment. In other words, the router 300c according to the third embodiment or the cell phone 600 according to the fourth embodiment may obtain the monitor resolution from the internally stored resolution table 520.

Modification 3:

The image upload routine shown in FIG. 3 may perform image transfer and reduction with regard to each image file individually or alternatively may perform image transfer and reduction with regard to plural image files collectively.

Modification 4:

The reduction ratio is calculated, based on the vertical resolution of the monitor resolution and the vertical resolution of the image data according to the above embodiment, but may be calculated, based on their horizontal resolutions.

Modification 5:

The above embodiments describe the applications of the image transfer device according to the invention to the removable storage device, the router and the cell phone. Besides, the image transfer device according to the invention may also be applicable to any of game machines, portable music players, personal computers, tablet, navigation systems, video recorders and video players that are capable of communicating via a network.

Modification 6:

According to the above embodiment, the image file created by the imaging device is stored in the flash memory included in the removable storage device and is deleted from the flash memory on completion of image transfer. According to another embodiment, the image transfer and the resolution conversion may be performed, while the image file (original image file) taken by the imaging device is stored in the internal memory of the imaging device. In this embodiment, the original image Me is not stored in the flash memory of the removable storage device, so that there is no requirement for deleting the original image file from the flash memory, and only the reduced file after the resolution conversion is stored in the flash memory.

While the invention has been described with reference to exemplary embodiments thereof, it is to be understood that the invention is not limited to the disclosed embodiments or constructions. On the contrary, the invention is intended to cover various modifications and equivalent embodiments. In addition, while the various elements of the disclosed invention are shown in various combinations and configurations, which are exemplary, other combinations and configurations, including more, less or only a single element, are also within the spirit and scope of the invention.

What is claimed is:

1. An image transfer device capable of communicating via a network, comprising:
a non-transitory storage device;
an image file obtainer that obtains an image file that includes first image data and identification information for identifying an image generation device used to generate the first image data;
an identification information obtainer that obtains the identification information from the obtained image file;
a resolution determiner that determines a display resolution of a monitor included in the image generation device, according to the obtained identification information;
a resolution converter that converts the first image data to second image data having a resolution consistent with the determined display resolution and stores the second image data into the storage device; and
an image transferrer that transfers the obtained image file to a first device connected to the network.

2. The image transfer device according to claim 1, wherein
the resolution determiner refers to a resolution table that has the display resolution of the monitor included in the image generation device stored in association with the identification information, and determines the display resolution.

3. The image transfer device according to claim 2, wherein
the resolution table is stored in a second device connected to the network, and
the resolution determiner refers to the resolution table stored in the second device via the network.

4. The image transfer device according to claim 1, wherein
the identification information obtainer starts obtaining the identification information at a timing of at least one of a timing when the image file is recorded in the storage, a timing when connection of the image transfer device to the network is detected and a timing when the image transfer device is powered on.

5. The image transfer device according to claim 1, wherein
the resolution converter calculates a conversion ratio used to convert the resolution, based on a vertical resolution of the first image data and a vertical resolution of the display resolution.

6. The image transfer device according to claim 1, wherein
the image transfer device being included in a removable storage device that is removably attachable to the image generation device.

7. The image transfer device according to claim 1, wherein
the image transferrer transfers the image file by wireless communication.

8. The image transfer device according to claim 1, wherein
the image file is stored in the storage device, and
the image file obtainer obtains the image file from the storage device.

9. The image transfer device according to claim 8, wherein
the image file obtainer deletes the obtained image file from the storage device, after the image transferrer transfers the obtained image file to the first device.

10. An image transfer method in an image transfer device capable of communicating via a network, the image transfer method comprising:
obtaining an image file that includes first image data and identification information for identifying an image generation device used to generate the first image data;
obtaining the identification information from the obtained image Me;
determining a display resolution of a monitor included in the image generation device, according to the obtained identification information;
converting the first image data to second image data having a resolution consistent with the determined display resolution and storing the second image data into a non-transitory storage device; and
transferring the obtained image file to a first device connected to the network.

11. The image transfer method according to claim 10, wherein
the display resolution is determined by referring to a resolution table that has the display resolution of the monitor included in the image generation device stored in association with the identification information.

12. The image transfer method according to claim 11, wherein
the resolution table is stored in a second device connected to the network and
the display resolution is determined by referring to the resolution table stored in the second device via the network.

13. The image transfer method according to claim 10, wherein
the obtaining the identification information starts at a timing of at least one of a timing when the image file is recorded in the storage, a timing when connection of the image transfer device to the network is detected, and a timing when the image transfer device is powered on.

14. The image transfer method according to claim 10, wherein
the converting the resolution uses a conversion ratio calculated, based on a vertical resolution of the first image data and a vertical resolution of the display resolution.

15. The image transfer method according to claim 10, wherein
the image transfer device is included in a removable storage device that is removably attachable to the image generation device.

16. The image transfer method according to claim 10, wherein
the image file is transferred by wireless communication.

17. The image transfer method according to claim 10, wherein
the image file is stored in the storage device, and
the obtaining the image file obtains the image file from the storage device.

18. The image transfer method according to claim 17, further comprising:
deleting the obtained image file from the storage device, after the obtained image file is transferred to the first device.

19. A non-transitory computer program product for image transfer performed by a computer capable of communicating via a network, comprising:
a non-transitory computer readable medium; and
a computer readable program recorded in the non-transitory computer readable medium, the computer readable program that when executed by the computer performs operations including
obtaining an image file that includes first image data and identification information for identifying an image generation device used to generate the first image data;
obtaining the identification information from the obtained image file;
determining a display resolution of a monitor included in the image generation device, according to the obtained identification information;
converting the first image data to second image data having a resolution consistent with the determined display resolution and recording the second image data into a storage device; and
transferring the obtained image file to a first device connected to the network.
